(19) United States
(12) Patent Application Publication
(10) Pub. No.: US 2008/0127932 A1
(43) Pub. Date: Jun. 5, 2008

(54) Diesel conversion to pneumatic engine zero emissions and fuel cost

(76) Inventor: Rudolph V. Bailey, Manassas, VA (US)

Correspondence Address: RUDOLPH V. BAILEY Sr., P.O. BOX 221911, CHANTILLY, VA, 20153, US

(21) Appl. No.: 12/002,514

(22) Filed: Dec. 17, 2007

Related U.S. Application Data
(63) Continuation-in-part of application No. 11/394,800, filed on Apr. 1, 2006.
(60) Provisional application No. 60/875,456, filed on Dec. 18, 2006.

(51) Int. Cl. F02B 3/08; F02D 29/06; F01B 29/04; H05B 6/04

(52) U.S. Cl. 123/27 GE; 219/670; 290/7

(57) ABSTRACT

A method of converting a diesel engine to a fuel-free and pollution-free pneumatic engine has been disclosed. A conventional diesel engine can be converted to a non-fuel-burning emission-free pneumatic engine. This can be accomplished by using the engine to operate a DC inverted to AC generator and using the AC current to operate a compressed-air device capable of delivering over 500 PSI and CFM enough to operate the engine in place of diesel fuel. Since the diesel engine compresses air to temperatures of about 1000 degrees F. and pressures of about 500 PSI, if one mixes it with cold air at pressures above 500 PSI a violent reaction will occur which will drive the engine piston downwards with force enough that when repeated in accordance with the engine's firing order it will cause the vehicle to self-propel along a surface.

### DESCRIPTION OF RELATED APPLICATIONS

This application is a continuation-in-part of CO-pending application Ser. No. 11/394,800 filed on Apr. 1, 2006.

### BACKGROUND

This version of the invention is concerned with the field of devices that can be used to convert the conventional diesel engine to a pneumatic engine, which will not give off any green-house gas emissions, nor is there any recurring fuel cost.

### PRIOR ART

No example has been found of a prior art device which perform the specified functions of converting the conventional diesel engine to a non-fuel-burning pneumatic engine. However CO-pending application Ser. No. 11/394,800 uses a similar principle in converting the conventional gasoline engine to a non-fuel-burning pneumatic engine. The difference with the present invention is that no heated compressed-air is used to perform the said conversion, since the compressed air in the conventional diesel engine cylinder is already heated to about 1000 degrees F., and a variable speed automatic clutch was also added to the DC inverted to AC generator shown in said CO-Pending Application.

### SUMMARY

The present version of the invention, which will be described in greater detail hereinafter, relates to the field of devices that can convert the conventional diesel engine to a pneumatic engine with zero harmful emissions, and zero recurring fuel cost. More specifically, this version of the invention is concerned with an engine conversion package employing a 3-way-valve locomotive type dual action high pressure high CFM compressed-air pump, designed for a new use, to convert the diesel engine to a pneumatic engine. The said air-pump is designed to be light weight and quiet and can deliver above 500 to 1500 PSI, and CFM capable to operate the desired engines, instead of diesel fuel. The invention includes other novel aspects that will be described in detail hereinafter.

Described briefly, according to a typical embodiment, the invention presents a diesel to pneumatic engine conversion package, incorporating a 110/220/440-volt-AC generator operated by the engine, which was first disclosed in CO-Pending application Ser. No. 11/394,800 filed Apr. 1, 2006. The said 440-volts-AC is used to operate an electric motor which in turn operates the said high pressure duel-action compressed-air-pump. In the present version of the invention the said high pressure air is used instead of diesel fuel to operate the engine. As revealed on page 5 of one of our prior application Ser. No. 10/886,459 filed on Jul. 7, 2004, Pneumatic and Fluid Engines, a science we at JESUS & Bailey call Pneumassism was disclosed. We would like to modify the word to ‘Pneumassvarism which stands for Pneumatic Mass Variation Scientific Methodology’. The original definition stated: “When air or gasses of varying temperature, volume, pressure, and velocity are suddenly mixed under certain conditions, they can cause a natural phenomenon uncontrolled violent reaction. Such uncontrolled violent reaction can be seen in a tornado, cyclone, or hurricane. Accordingly if one can simulate these conditions in a controlled environment such as an engine, said violent pneumassis reaction can be used to produce motion and propulsion, for land marine and air travel, and to generate electrical energy.” We would like to modify the original definition as following; Jesus & Bailey states: “When air or gasses of varying temperature, pressure, mass, velocity, and volume are suddenly mixed under certain conditions, they can cause a natural phenomenon un-controlled violent reaction such as is seen in a tornado or cyclone. If one can simulate these condition in a controlled environment such as an engine, the said natural phenomenon un-controlled violent reaction can be used to cause motion and propulsion for land, air, and marine transportation, and to generate electrical energy; thereby delivering free and clean energy. Accordingly as the cold higher pressure and velocity compressed air is suddenly mixed with the static higher temperature and lower pressure air in the cylinder; said violent reaction drives the piston downwards with force enough, that when repeated according to the engine's original firing order, it causes said engine's crankshaft to rotate for its several purposes, such as for use in transportation devices and for generating electrical energy.

My invention, therefore, resides not in any one of these features per se, but rather in the particular combination of all of them disclosed. This invention does not seek to claim any portion of prior art revealed in the previous applications sighted.

In order that the detailed description of the invention may be better understood and that the present contribution to the art may be more fully appreciated, additional features of the invention will be described hereinafter. It should appreciated by those skilled in the art that the conception and the disclosed specific methods and structures may be readily utilized as a basis for modifying or designing other structures, for carrying out the same purposes of the present invention. It should be realized by those skilled in the art that such equivalent methods and structures do not depart from the spirit and scope of the invention.

In This respect, before explaining at least one embodiment of the invention in detail, it is to be understood that the invention is not limited in its Application to the details of construction and to the arrangements of the components set forth in the following description, or illustrated in the drawings. The invention is capable of other embodiments and of being practiced and carried out in various ways. Also, it is to be understood that the phraseology and terminology employed herein are for the purpose of description, and should not be regarded as limiting.

As such, those skilled in the art will appreciate that the conception, upon which this disclosure is based, may readily be utilized as a basis for designing of other structures, methods and systems for carrying out the several purposes of the present invention.

Further the purpose of the foregoing abstract is to enable the U.S. Patent and Trademark office and the public generally, and especially the scientists, engineers, and practitioners in the art, who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

Accordingly, it is an object of my version of the invention to provide a low-cost, easy-to-manufacture, and easy-to-market Diesel to pneumatic Engine Conversion package with zero harmful emissions, and zero recurring fuel cost.

A further object of my version of the invention is to provide an easy-to-install and easy-to-operate Diesel to Pneumatic Engine Conversion Package with zero harmful emissions, and zero recurring fuel cost.

A significant object of my version of the invention is to provide light-weight and quiet Diesel to Pneumatic Engine conversion package with zero harmful emissions, and zero recurring fuel cost.

Another object of my version of the invention is to provide a conversion package for the conventional diesel engine which will allow the converted pneumatic engine a verity of new uses such as for indoor electrical generators and welding machines and such like applications.

A final but very significant object of the invention is to provide a conversion package that is easy-to-service and easy-to-maintain.

Additionally an important advantage of my version of the invention to provide a Diesel to Pneumatic Engine Conversion Package that will save lives in some accidents since no combustible fuel is used, and will improve the health and wellness to humans world-wide since the related health hazards due to air pollution is eliminated.

Furthermore it is an important advantage of my version of the invention to provide a Diesel to Pneumatic Engine Conversion Package that will help to rid the Nation from its dependence to imported foreign oil.

A significant advantage of our version of the invention is to provide a Diesel to Pneumatic Engine Conversion Package that will allow consumers to have more money to spend on other goods and services, since they will not have to pay for fuel on a continuous basis.

An additional advantage of our version of the invention is to provide a Diesel to Pneumatic Engine Conversion Package that will save money and lower operating cost for the business, corporate and industrial sector, since the cost of fuel will be eliminated.

Another important advantage of our invention is the versatility of the conversion package to allow the converted diesel engine to be used for indoor applications in facilities inhabited by humans since unlike conventional diesel engines there are no harmful emissions

A final but very significant advantage of our version of the invention is to provide a Diesel to Pneumatic Engine Conversion Package that will help to rid the planet form green-house gas emissions and from global warming and its projected catastrophic consequences.

For a better understanding of the invention, its operating advantages and specific objects attained by its uses, references should be made to the accompanying drawings and descriptive matter in which there is illustrated a preferred embodiment of the invention. The foregoing has outlined some of the more pertinent objects and advantages of the invention. These objects and advantages should be construed to be merely illustrative of some of the more prominent features and applications of the present invention. Many other beneficial results can be attained by applying the disclosed invention in a different manner or by modifying the invention within the scope of the disclosure. Accordingly, other objects and advantages and a fuller understanding of the invention may be had by referring to the summary of the invention, and the detailed description of the preferred embodiment, in addition to the scope of the invention illustrated by the accompanying drawings.

### BRIEF DESCRIPTION OF THE DRAWINGS

The foregoing and other objects, features and advantages of the invention will become more fully understood from the following description of the preferred embodiment of the invention as illustrated in the accompanying drawings in which like reference characters refer to the same parts throughout different views. The drawings are not necessarily to scale, emphasis instead being upon illustrating the principles of the invention.

FIG. 1A is an elevation view of a 3-way-valve locomotive type dual action high pressure and cubic feet per minute (CFM) compressed-air pump, designed for a new use, illustrating the mechanical and some electrical components, and ready to pump to the ‘A’ port.

FIG. 1B is an elevation view of the same dual action compressed air-pump as in FIG. 1A, but ready to pump to the ‘B’ port.

FIG. 2 IS a schematic assembly diagram illustrating the complete conversion package with all components installed to the old diesel engine to perform the new said conversion to a pneumatic engine.

FIG. 3 IS a perspective view of a converted passenger bus illustrating a new compartment at rear to house conversion package.

FIG. 4 is an elevation view of a new converted dump truck illustrating an external weather proof compartment with air-vents, in order to accommodate conversion package.

FIG. 5 is an elevation view of a converted moving truck illustrating how the over-cab-compartment can be modified for a new use to accommodate conversion package.

FIG. 6 is an elevation view of a converted tractor for trailer illustrating an external compartment with garage type overhead doors in order to accommodate conversion package.

FIG. 7 is an elevation view of a converted diesel to pneumatic engine used to operate an electric generator instead of a transportation device.

### DRAWING REFERENCE NUMERALS ABBREVIATIONS & NOMENCLATURE

24 Air-Admittance Valve
49 Hot Wire to Contact Switch
50 Hot Wire from Contact Switch
52 Pressure sensing line (to pressure control switch 264)
57 Pneumatic Plug
256 Fly Wheel Pulley
258 440-Volt Motor
260 Shut-off Valve
262 110-Volt Wire to 3-Way Valve
264 Pressure Control
266 Pressure Gauge
268 Compressed-Air Holding Tank
270 Drain Valve
272 Check Valve
274 3-Way Valve
275 Exit-connecting Pipe (to air-storage tank)
276 Pump Support Leg
278 4-Vent Valves
280 4-Normally Open Contact Switch (outer casing made of plastic)
282 110-Volt-AC Switching Solenoid
283 Intake Air-Filter Unit
284 High-Pressure-Air-Line
285 High Pressure Air-tubing (from air-admittance valve to Pneumatic plug)
286 110-Volt-AC Wire to Vent Valve V2
287 Attachment Hardware
288 Electrical Connection Box
290 Flywheel Support Bracket (welded to channel iron base)
292 Blast Of Cold High Pressure Compressed-Air (replaces diesel fuel)
293 Spring
294 Pressure Gauge (located in instrument panel inside vehicle)
295 Spring-Loaded Contact
296 440-Volt-AC Wire to Pump Motor & Controls
297 Spring-Loaded Rubber Stop
298 Air-Pressure-Regulator
299 Air-Regulator Idle Adjusting Mechanism
300 Regulator connecting Rod to Accelerator Linkage
302 110-Volt-AC Wire to Solenoid's N.O. Contact (to Vent V2}
303 110-Volt-AC Wire to Solenoid's N.C. Contact (to Vent V1)
304 110-Volt-AC Wire to Solenoid's N.O. Contact (to 3-Way Valve)
306 Accelerator Pedal linkage arrangement
308 Front and Rear Harness (for air-distributor)
310 Shaft Packing Seal
312 Channel Iron Base (welded to pump housing pipe)
314 10-High Pressure Swivel Flanges
315 Electrical Connection Box
316 Rubber-Insert Grommets
318 Terminal screws Nuts & Washers
320 High Pressure Steel Pipe
322 High Pressure Air-Pump Plunger
323 Bevel on Front and Rear Leading Edges
324 High Pressure Air-Pump Cylinder
326 Air-Plunger Shaft
328 Flywheel Lever
330 Automatic Oilier Receiver
331 Oil Container
332 Spacer Shaft
334 Per-cast Grove (in plunger at contact points to receive inserts 316)
336 Knock-out Holes for Wires to pass through
338 Compartment for Conversion Package
340 External Conversion Package Compartment
342 Weather-Proof Air-Vent Louvers
344 Compartment Side Door Handles
346 Rear Door (not shown)
347 Overhead Door Handles
348 Hydraulic Lift controls
350 Hydraulic Lift
352 Hydraulic Riser
354 Roller wheels
356 Cotter Pin in Support Rod
358 Tail-Gate Locking-Rod
360 Tail-Gate Locking-Clip
362 220-Volt-AC Cab-Top Air-Conditioner
364 Over-Cab Compartment for Conversion Package
365 Exterior Access Door Handle
367 Interior Access Door Handle
368 Weather-Proof Air-Vent
370 Side Access Door Handle
372 Over-Head Door Track
374 Hoses and Wires (for tractor trailer)
376 Compartment for Conversion Package (for tractor trailer)
378 Variable Speed Automatic Clutch
520 Air Distributor
522 Engine Drive Chain
524 Electric Generator Automatic transmission/Gear Box
526 110/220-VAC Electric Generator
528 220/440-VAC Transformer
530 110/220/440-VAC Circuit Breaker Box & Engine Control Panel
AC Alternating Current
ALT Alternator
Batt. Battery
(CD) Contact-switch Detail
CFM Cubic Feet/Minute
E Exit Port
(M) Motor
C Closed
O Open
PSI Pounds/Square-Inch
(S) Solenoid
(V) Valve

### DESCRIPTION OF THE PREFERRED EMBODIMENT

### Description

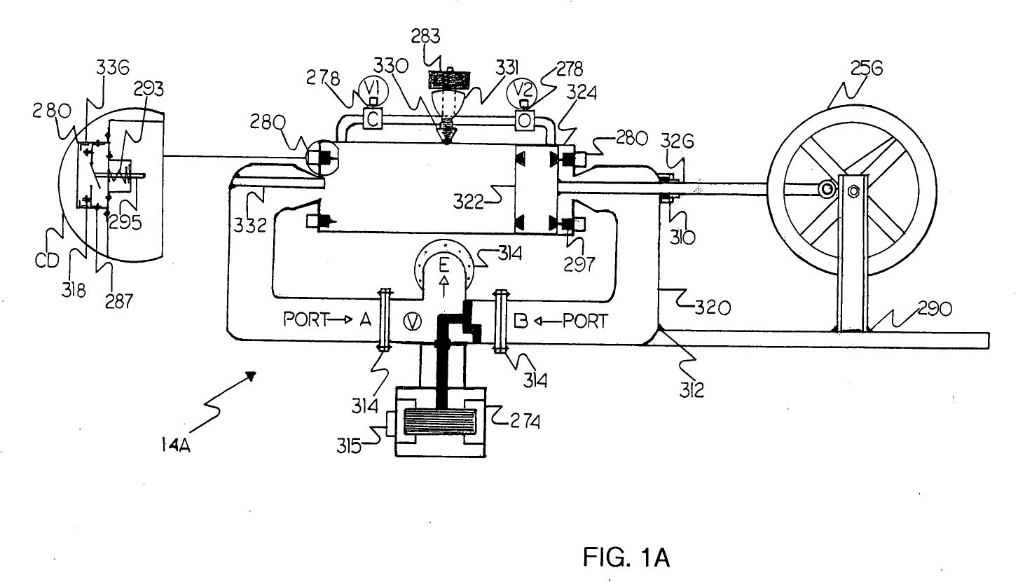

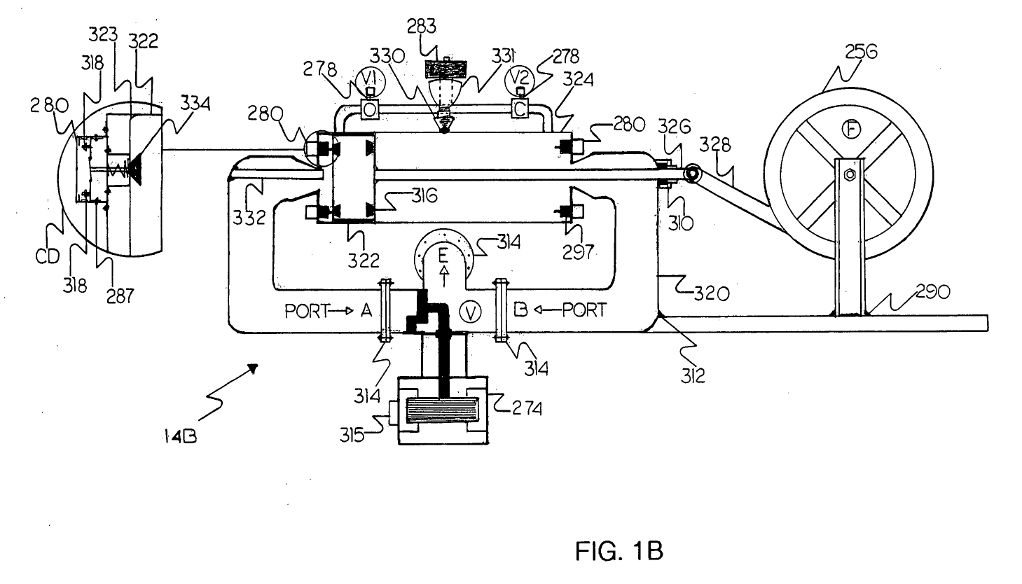

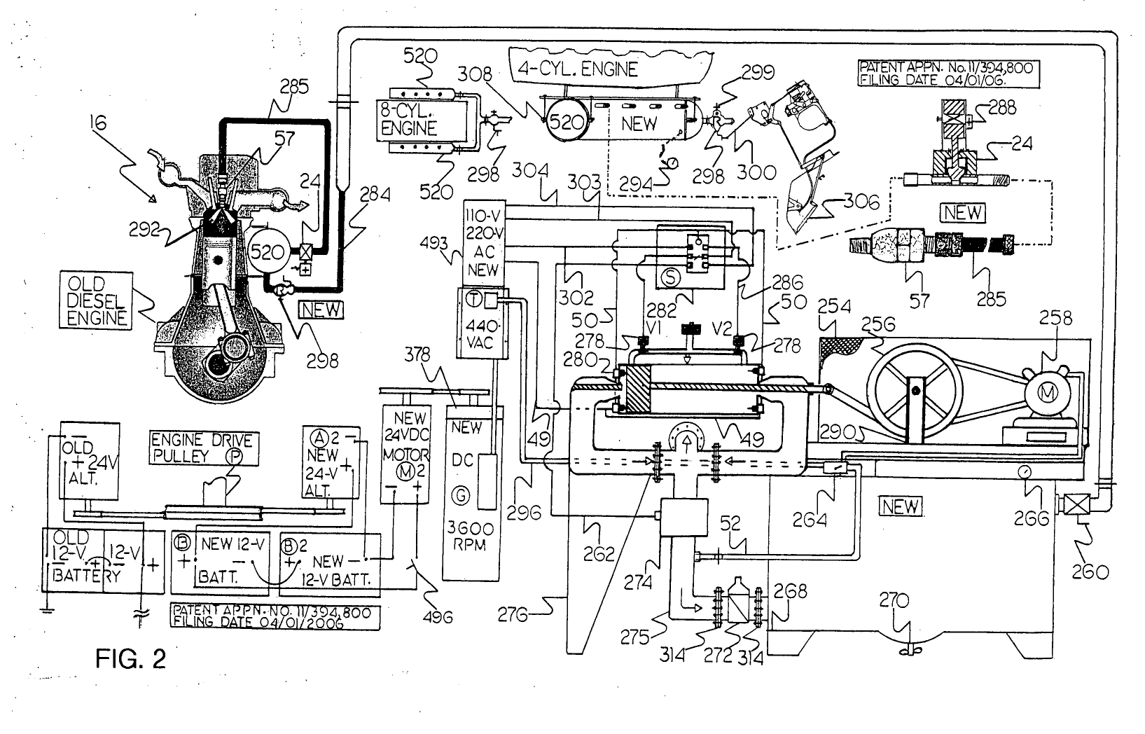

Referring now to the drawings and in particular, to FIG. 1A wherein there is illustrated a typical embodiment of a dual-action 3-way-valve locomotive type high pressure and CFM compressed-air pump 14A. The present version of the invention 14A is designed for a new use to convert the conventional diesel engine to a pneumatic engine, with zero harmful emissions and zero recurring fuel cost. The present version of the invention 14A is constructed of materials and components that are lightweight, quiet, durable, and resistant to corrosion and oxidization, such as rudder, plastic, aluminum, carbon steel, or stainless steel, various composite materials or a combination thereof. The device 14A consist of a steel high pressure air-pump cylindrical section 324 machined to mate with a steel high pressure air-pump plunger 322. High pressure steel pipe 320 is connected to each end of cylinder 324 as illustrated, with reducing cone ends. Air-plunger-shaft 326 is connected to flywheel-lever 328 (FIG. 14B) by appropriate hardware to allow lever 328 to move freely up and down, and in and out as flywheel pulley 256 rotates. Said rotating action of flywheel 256 will cause plunger 322 to move forward and backward in a pumping action in each direction. Flywheel 256 is supported by bracket 290 which is appropriately attached to base 312, which is also appropriately attached to pipe 320 as illustrated. Other end of pipe 320 is attached to 3-way-valve 274 by high-pressure-flanges 314, as illustrated, or by other appropriate means. Air-plunger-shaft 326 is sealed for air-tight operation through shaft-packing-seal 310 which should allow shaft to move freely while maintaining a air-tight seal. Plunger 322 has pre-cast cone-shape-grove 334, at contact-points 295 as illustrated in FIGS. 1A & 1B, to receive rubber-insert-grommet 316. Rubber grommet 316 makes contact with spring-loaded rubber-stop 297 for quiet operation, and to prevent electrical shock. Automatic-oilier-receiver 330 has a spring-loaded steel-ball which is forced upwards as plunger 322 passes, allowing a small amount of oil to lubricate plunger on each pass. Oil container 331 is screwed into receiver 330, and is replaced when empty. A conventional oil level indicator can be installed in dash board. Bevel 323 (FIG. 1B) is cut on each leading edge of plunger 322 to help it to move freely under receiver 330 mechanism. Spacer-shaft 332 equalizes space at cylinder 324 exit ports, and filter compartment 283 cleans intake air. FIG. 1A shows pump in ready position to pump air through port ‘A’, while FIG. 1B shows pump ready to pump air through port ‘B’ In each pump position air exit pump at port ‘E’, to air storage tank 268 in FIG. 2.

Referring now to FIG. 2, therein illustrated is a typical embodiment of an assembly diagram of a diesel conversion to pneumatic engine 16. The present version of the invention i6, illustrates the tie-in to the old conventional-diesel-engine. As previously mentioned in CO-pending application control Ser. No. 11/394,800 the engine was used to operate a 110/220/440-volt-AC generator as illustrated, a patent is not sought on that idea, however it is included to show how we will achieve the alternating current needed to operate the said high-pressure compressed-air pump 14. A slight modification is made to DC inverted to AC generator a variable speed automatic clutch 378 is included. The clutch will neutral the generator at zero Amps, and increases the generator's speed to accommodate the desired load. Pump 14 is shown mounted on air-storage-tank 268, and motor 258 is also appropriately installed along with guard 254, and support-legs 276. Additionally exit port E connecting line 275 is connected to check valve 272 which is connected to tank 268. Sensing-line 52 is connected to pressure-control 264. Additionally 440-volt-AC line 296 is connected to motor 258 via pressure-control 264. Motor 258 is used to operate high-pressure air-pump 14, (FIGS. 1A & 1B). In addition pressure gauge 266 and manual-shut-off-valve 260 is installed as well as high-pressure-air-line 284, with reducer as illustrated for quick pressurizing of air-distributor 520. Installed also is air-regulator 298 to air-distributor 520, and air-admittance-valves 24 as illustrated. Air-distributor 520 is installed to convenient location on old engine as illustrated for 4, 8, or any other number of cylinders. Pneumatic injector plugs 57 are installed to old engine block in place of fuel injectors as illustrated. Install high-pressure tubing or air-hose 285 to air-admittance-valve 24, and pneumatic-injector-plugs 57 as illustrated. Air-admittance-valve 24 operates on 24-volts in this example. Remove old fuel accelerator linkage connection, and fuel pump and fuel lines and fuel tank. New accelerator linkage 300 is installed to air-regulator 298 and existing accelerator pedal linkage arrangement 306. All components mentioned in conjunction with air-distributor 520 was covered in CO-Pending application control Ser. No. 11/394,800 and a patent is not sought for them, however there is one difference in this version of the invention, no heating element is needed for air-distributor 520 since the air in the diesel cylinder is already heated.

Referring again to FIGS. 1A & 1B, and, in particular to contact switch 280, detail (CD), connect wires through knock-out holes 336 (FIG. 1A) to terminals 318 on both ends of switches 280, on either end of cylinder 324 as shown as wires 49 & 50 in (FIG. 2). When plunger 322 makes momentary contact with pointer 295, switch 280 closes and power will pass though wires to coil on switching solenoid 282 as shown in (FIG. 2). When plunger 322 moves back in other direction, spring 293 will return switch 280 to the normally open position.

Referring back to FIG. 2 As power goes to the coil of solenoid 282; all contacts are reversed and stay in that position until the coil is powered again reversing the contacts once more. The coil will stay in that position until powered again repeating this action back and forth. Since power is always at the bottom of switch 280, on line 49, the coil on solenoid 280 will receive power momentarily from line 50 when plunger 322 makes contact with switch 280 at either end of cylinder 324.

Referring again to FIGS. 1A & 1B, when pump 14 is in the ‘A’ position vent valve V1 is closed and vent valve V2 is open so that the plunger 322 will suck air in through vent valve V2. When pump 14 is in the ‘B’ position vent valve V2 will be closed and valve V1 will be open to suck air in through vent valve V1. Solenoid 282 FIG. 2 will control their operation as stated. Solenoid 282 will also control the switching of 3-way-valve 274 from port A to port B in conjunction with vent valves V1 & V2.

Referring again to FIG. 2 before attempting to operate vehicle compressed-air-tank 268 must be filled to capacity by an external source, once conversion is made. Tank 268 can also be pressurized by connecting an external 440-volt-AC line to the appropriate internal wires in pressure control switch 264, by a qualified electrician, and then by turning switch 264 to the ON position. Once tank 268 is fully pressurized air-distributor 520 should be pressurized by setting air-regulator 298 at 520-PSI by adjusting air-regulator idle-adjusting-mechanism 299. Any other suitable engine idle pressure can be used. When all components are installed and assembled as illustrated, and all air-lines and containers and joints are air-tested and no leaks are found, the engine will be ready to be started. When the accelerator is depressed air regulator will increase the pressure to air-distributor 520 which will cause the engine to increase in speed

To start engine turn ignition key to start position as normally done. As the starter cranks the engine cold high pressure air will be suddenly mixed with high temperature static pressurized air in engine cylinders causing a violent reaction as explained in the summary of the invention. The said violent reaction will drive the engine piston downwards with force and velocity enough that when repeated will cause the engine crank-shaft to rotate, which will cause the vehicle to self propel along a surface. The compressed air in the diesel engine cylinder will be at about 500 pounds per square inch (PSI) at a temperature of about 1000 degrees F., and the compressed air which replaces diesel fuel will be 520-PSI, and above, and will be at room temperature. When both compressed air differential pressure and temperature and velocity, and mass are suddenly mixed they will causes a violent reaction which supplies the force needed to operate the engine instead of diesel fuel. This will eliminate green-house gas emissions, and fuel cost.

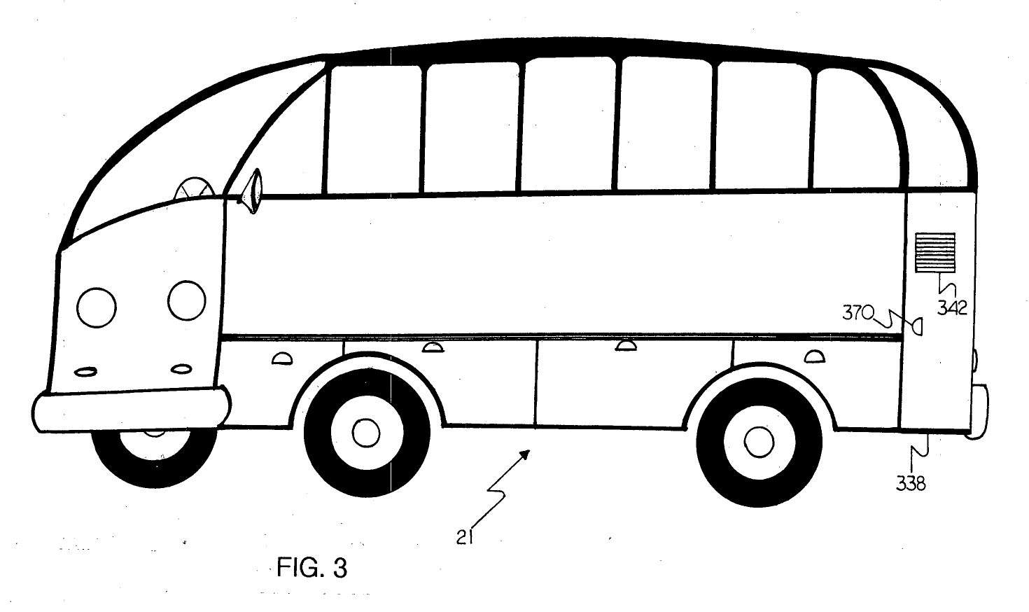

Referring now to FIG. 3, wherein is illustrated a passenger bus 21. The present version of the invention 21 is shown as illustrating a rear compartment 338 with vent lovers 342 and handle 370 for a new use, to house a diesel to pneumatic engine conversion package.

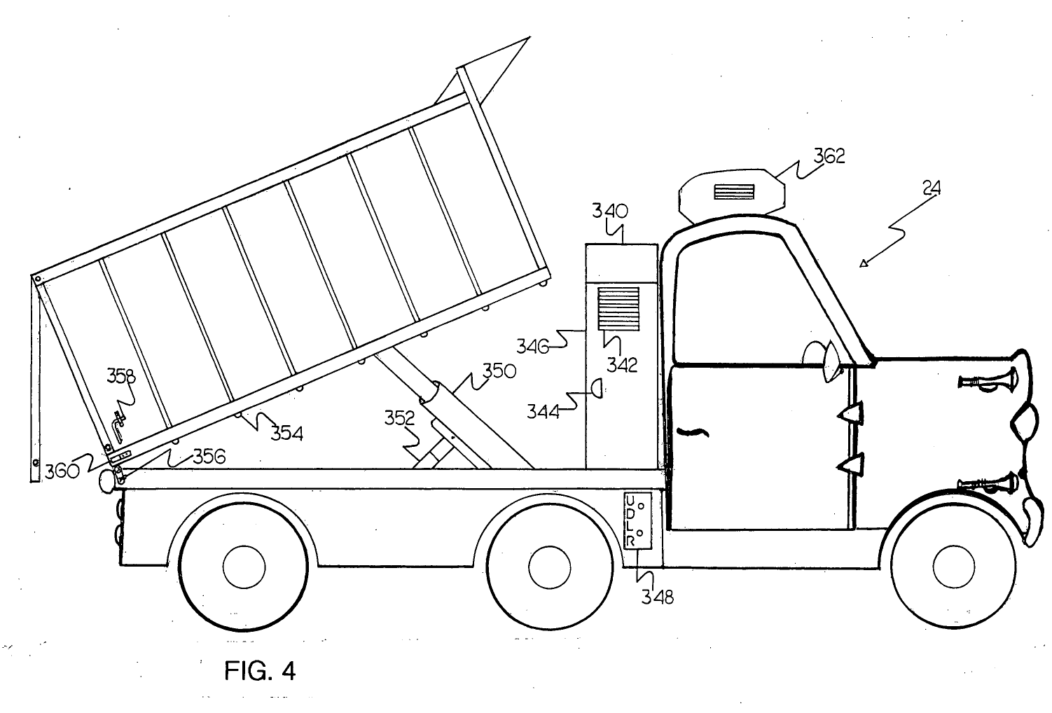

Referring now to FIG. 4, wherein there is illustrated a dump body truck 21. The present version of the invention 21 is designed for a new use to accommodate an external weather-proof compartment 340, to house a diesel to pneumatic engine conversion package. An electric air condition unit 362 is also mounted on cab of truck, in a case where the air condition unit is removed from the engine to accommodate a second alternator for the conversion.

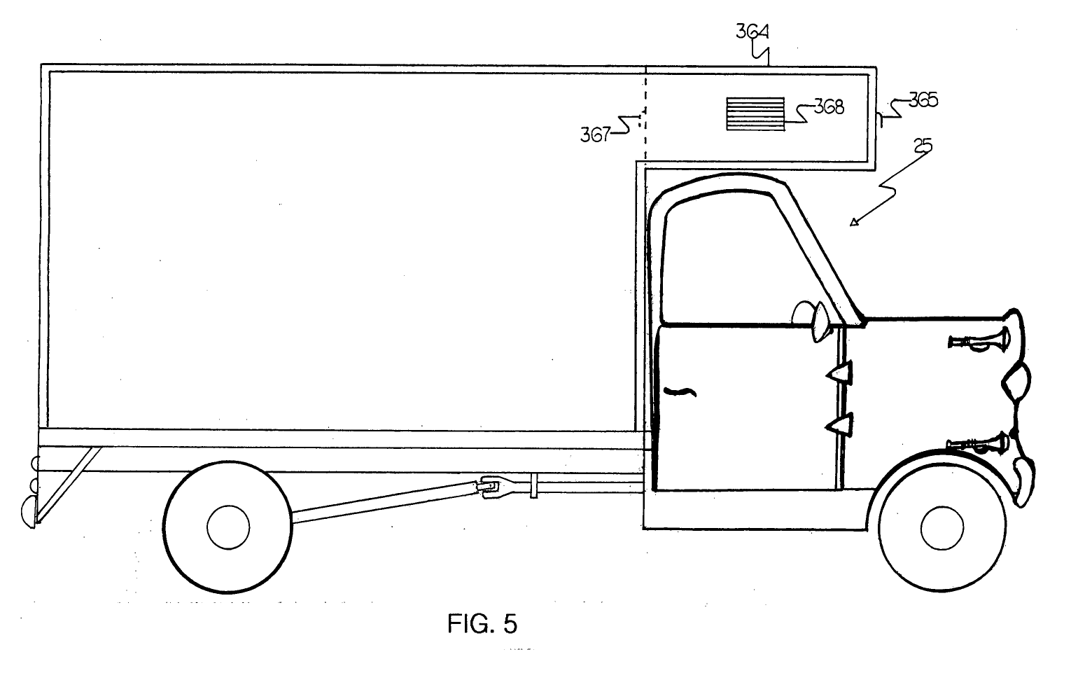

Referring now to FIG. 5, wherein is illustrated a typical embodiment of a moving body truck 25. The present version of the invention 25 illustrates how the over cab compartment could be modified with doors and vent louvers for a new use to house a diesel to pneumatic engine conversion package.

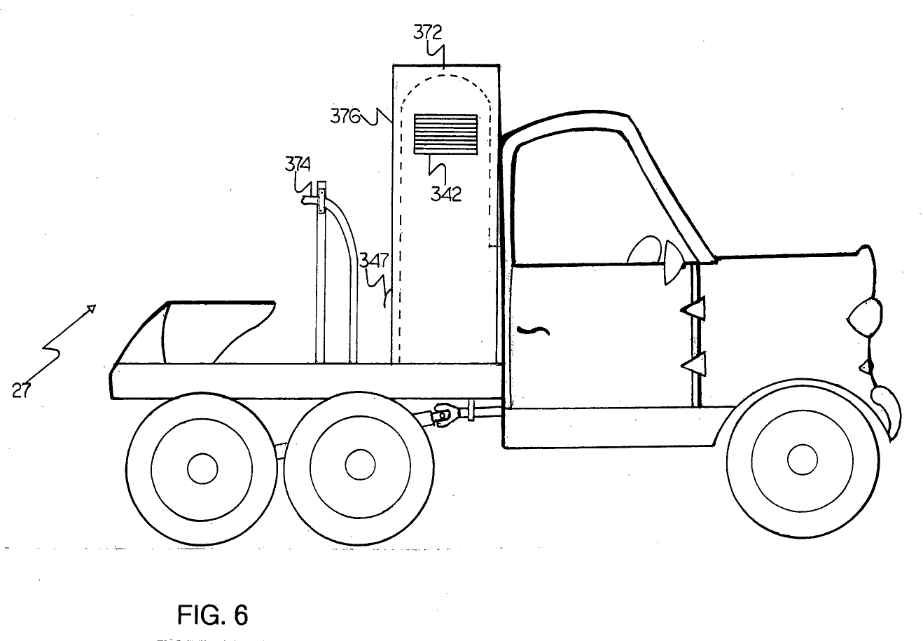

Referring now to FIG. 6, therein is illustrated a typical embodiment of a tractor for a commercial trailer 27. The present version of the invention 27 illustrates an external weather proof compartment 372, designed for a new use to accommodate a diesel to pneumatic engine conversion package. All compartments must have access doors with handles and locks, and must be large enough to allow installation of conversion package. Additionally vent louvers must allow enough cross ventilation to allow motors pumps and other components to operate properly and safely. Additionally compartment 372 has a garage type overhead door 376 with handle 347. The invention 25 also has support for trailer connections 374.

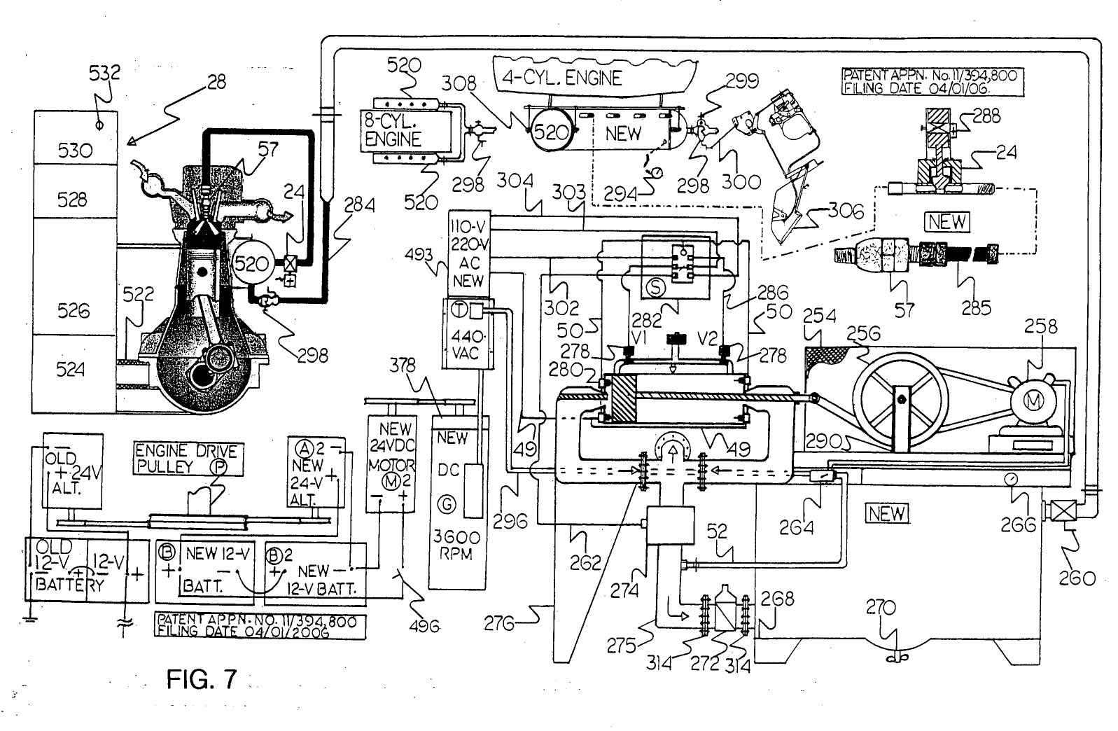

Referring now to FIG. 7 wherein is illustrated a typical embodiment of a 110/220/440-Volt-AC generator 28, the present version of the invention 28 is made of conventional component parts including a engine drive chain 522, or any other commercially accepted rotary transmission means to operate automatic transmission 524. The device 28 also contains a commercially accepted alternating current electric generator 526 which is driven by automatic transmission 524. Generator 526 can vary in output depending on need. Engine 16 which drives automatic transmission 524 can be of any appropriate horse power to achieve the load output of generator 526. The device 28 also includes a 220/440-volt alternating current transformer 528. Additionally a circuit breaker cabinet and engine control panel 530 is installed. The electric generator can also be connected directly to the engine's crank-shaft or drive shaft. Additionally the converted engine can also be used as a welding machine. Both the electric generator and the welding machine is a new use for indoor applications in facilities inhabited by humans, since unlike the conventional diesel engine there are no harmful emissions. Unlike the conventional diesel generators the invention 28 can operate continuously since no fuel needs to be added.

In order to operate the generator or welding device 28 turn starters key 532 until engine cranks and release. Engine will idle and increase in speed with load output demand. To stop operation turn key 532 in opposite direction until engine stops.

### RAMIFICATION CONCLUSION AND SCOPE OF INVENTION

From the foregoing, it will be understood by persons skilled in the art that an improved diesel to pneumatic engine conversion package has been provided. The invention is relatively simple and easy to manufacture, yet affords a variety of uses, such as transportation devices, lifting machines, earth moving equipments, and electrical generators and such like. While my description contains many specifications, these should not be construed as limitations on the scope of the version of the invention; instead they are exemplifications of the preferred embodiment thereof. The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be resorted to, falling within the scope of the invention. Although this invention has been described in its preferred form with a certain degree of particularity, it is understood that the present disclosure of the preferred form has been made only by way of example, and numerous changes in the details of construction and combination and arrangement of parts may be resorted to without departing from the spirit and scope of the invention.

1. What I claim is the principle of converting conventional diesel engines to non-fuel-burning pneumatic engines with zero harmful emissions and zero recurring fuel cost comprising:
(a) providing dual-action 3-way valve locomotive type high pressure and CFM compressed-air pump designed for new use for transportation industry and
(b) providing high pressure air storage tank connected to said pump and
(c) providing electrical and pressure controls capable of controlling the safe operations of said pump and
(d) delivering said high pressure and CFM compressed-air to engine instead of diesel fuel whereby as hot high pressure static compressed air in engine cylinders are suddenly mixed with cold higher pressure and velocity compressed-air from said compressed-air pump a violent reaction is produced which drives the crank shaft downwards with force enough that when repeated according to engine's firing order causes vehicle to self propel from one place to another.

2. What I claim is the new use of new and existing designs which provides extra storage space and or compartments to house a conversion package which converts any engine to a non-fuel-burning and harmful emission free pneumatic engine comprising:
(a) interior and exterior weather-proof compartments and or space with
(b) weather-proof access doors with locks and handles and
(c) weather-proof vent louvers sufficient to vent motors pumps and such like components needing air for proper and safe operation whereby as said conversion package is securely assembled and installed in said space and or compartments said conversion package becomes a permanent part of vehicle said engine operates.

3. What I claim is the new unforeseen and unintended use of the following prior art components and parts to accomplish conversion of the conventional diesel engine to eliminate the use of diesel fuel to operate said engine and to replace it with high pressure and high CFM compressed-air as a fuel source comprising:
(a) electrically operated 3-way-valves and standard valves and
(b) Electrical spring loaded limit switches and pressurized on/off control switches and
(c) 220/440-volt-AC electric motors and
(d) Fly-wheel type pulleys and regular pulleys and
(e) High pressure steel flanges and valves and
(f) 110-volt-AC solenoid which transfer contacts when powered and hold that position with no power and reverses position when powered again and hold that that position with no power and changes only when powered again whereby when said major components and parts are assembled as in specification and independent claim No. 1 the purposes of independent claim No. 1 will be realized.

4. What I claim is the continuous new use of a converted diesel to pneumatic engine with zero harmful emissions and zero recurring fuel cost to operate electrical generators or welding machines for indoor use in facilities inhabited by humans comprising:
(a) providing rotary transmission means from said converted engine and
(b) providing 110/220-volt-AC electric generator which is connected and driven by said engine and said rotary transmission means to deliver 110/220-volts-AC to a load and
(c) providing 220/440-volt-AC transformer connected to deliver 440-volts to a load and
(d) providing circuit breaker and control cabinet connected to operate said converted engine and to regulate said electrical energy whereby as said engine is operated said electrical generator supplies continuous 110/220/440-volts to a load or for welding operations with zero harmful emissions and zero recurring fuel cost in indoor facilities inhabited by humans.
